(19) United States
(12) Patent Application Publication
(10) Pub. No.: US 2001/0056373 A1
(43) Pub. Date: Dec. 27, 2001

(54) Performer collection for promotion video through internet and production of promotion video

(75) Inventor: Masaru Sanada, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/884,989

(22) Filed: Jun. 21, 2001

(30) Foreign Application Priority Data
Jun. 23, 2000 (JP) 2000-190111

(51) Int. Cl. G06F 17/60

(52) U.S. Cl. 705/14

(57) ABSTRACT

A performer collecting company releases collection of performers in a promotion video through the Internet. Information viewers view collecting information provided by the performer collecting company on information terminals. Applicants transmit information based on the collecting information from the information terminals to the performer collecting company through the Internet. The performer collecting company selects a performer from the applicants based on the received information. The image of the selected performer is used to produce a promotion video by replacing part of an original promotion video in which a performer appears by the image of the selected performer.

### BACKGROUND OF THE INVENTION

1. Field of the Invention

The present invention relates to a method of collecting performers in a promotion video suitable for use in collection of performers in a commodity promotion video using the Internet, and a production method of the promotion video.

2. Description of the Related Art

In sales promotion of commodities, a high degree of effectiveness can be expected in advertisements for commodities through mass media, for example through the medium of television, since such advertisements can let many people know of the commodities in a short time by video and sound and widely provide people with topics on the commodities. Conventionally, these kinds of promotion videos are classified into two; one intends to enhance recognition of a sold commodity mainly with the appearance of a talented performer such as an actor or a professional sport player, and the one intends to advertise a commodity for its effects or usability in use from a user's standpoint with the appearance of an ordinary consumer. For a video with the appearance of a consumer in the latter case, people who wish to appear in the video are collected in a relatively limited range to request their appearance.

The aforementioned conventional method, however, suffers from some problems. Specifically, in the case of a promotion video with a performer, he attempts to sell a commodity in the advertisement only from his side, which may be thought as an imposition. In the case of a user describing the effects of a commodity, the impact of commodity advertising is small. In addition, if the same image is repeatedly used in such a promotion video, impressions on viewers are weaker, which results in no effects. Thus, different promotion videos must be made frequently to produce effects, thereby presenting a problem of a higher cost.

### SUMMARY OF THE INVENTION

It is an object of the present invention to provide a method of collecting performers in a promotion video capable of widely collecting performers in a promotion video, producing the promotion video with participation by many people, and attracting interest in an advertised commodity.

It is another object of the present invention to provide a method of producing a promotion video capable of maintaining the novelty of the video.

According to one aspect of the present invention, collecting information for collecting a performer in a commodity promotion video is displayed on information terminals of applicants through the Internet to collect applicants. A performer is selected from applicants who made application from the information terminals, and is notified of the selection.

The release of the performer collection for a promotion video through the Internet provides topics to many people, and the commodity can be more well-known.

According to another aspect of the present invention, part of an original promotion video formed with the appearance of a performer is replaced by an image of a collected performer to produce a promotion video which is inserted into the original video for a certain period of time.

Since the original promotion video can be repeatedly used by changing performers and the performers pay a charge for appearance, the cost of producing the video can be reduced and the entire cost for broadcasting the promotion video can be reduced. In addition, since the performers can have awareness of participating in sales promotion and attachment to the commodity, the ripple effect of advertising stretches widely to lead to promotion of sales.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a conceptual illustration of a system according to an embodiment of the present invention;

FIG. 2 is a flow chart illustrating a procedure for performer collection and promotion video production;

FIG. 3 is a schematic diagram illustrating replacement by an image of a performer; and

FIG. 4 is a schematic diagram illustrating replacement by an image of persons other than a performer.

### DESCRIPTION OF A PREFERRED EMBODIMENT

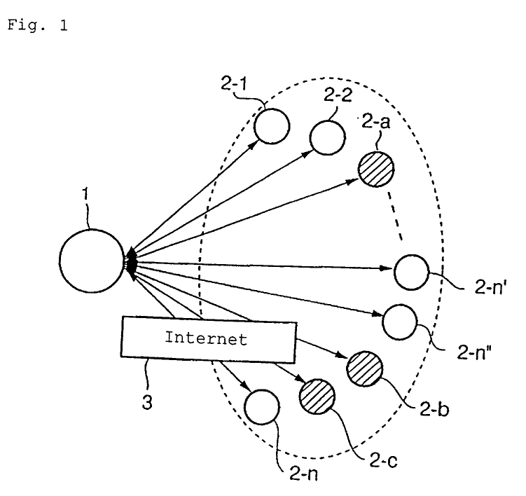

FIG. 1 is a conceptual illustration of a system according to an embodiment of the present invention, and shows a case in which performer collecting company 1 supplies collecting information to information terminals of information viewers 2-1 to 2-n through Internet 3, and information viewers 2-a to 2-c of information viewers 2-1 to 2-n make application.

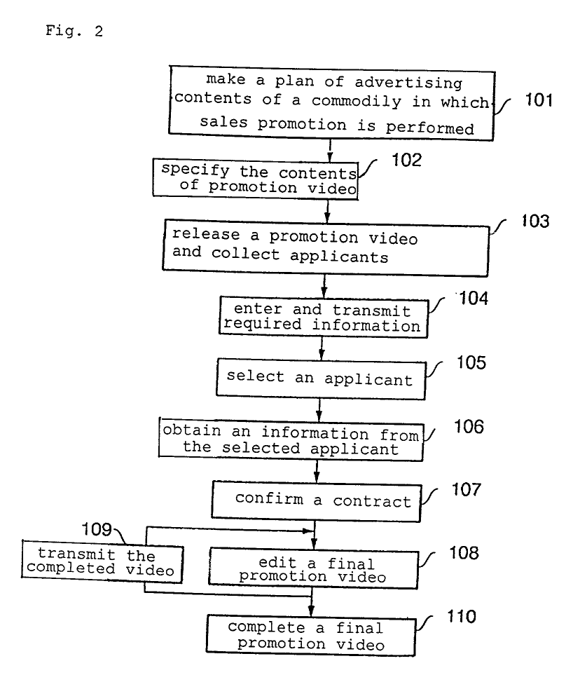

The operation of the embodiment will be described with an example in which applicant 2-a is selected as a performer with reference to FIG. 2.

First, in step 101, performer collecting company 1 makes a plan of advertising contents of a commodity for which sales promotion is performed. In accordance with the advertising contents, a performer is selected with talent suitable for the image of the commodity, for example actors or professional sport players. In addition, performer collecting company 1 selects a scene, light, color, sound, music and the like which are materials required for improving the image of the commodity. In step 102, the contents of a promotion video are specified in consideration of the performer and these materials to produce an original video. The promotion video is broadcast through media.

Next, performer collecting company 1 produces collecting information including the original promotion video, application conditions and the like to collect people who wish to appear instead of the performer in the original promotion video. In step 103, the produced information is stored in a WWW (World Wide Web) server or entered in an electronic bulletin board formed by a network provider, and released to an indefinite number of viewers through Internet 3. The released collected information includes description of a portion in the original promotion video to be replaced by an image of an applicant, for example, the face, entire body, or voice of a person playing a leading role, broadcast schedules, a charge for appearance as an application condition and the like.

Information viewers 2-1 to 2-n view the collected information by using WWW browsers of information terminals. In step 104, applicants 2-a to 2-c who wish to appear in the video enter required information into the information terminals based on the collected information and transmit the information to performer collecting company 1. In step 105, performer collecting company 1 selects a performer who is considered suitable for the promotion video based on the information received from applicants 2-a to 2-c in consideration of the image of the commodity to be advertised and the like. Next, performer collecting company 1 requests selected applicant 2-a to produce an image matching the action of the performer in the original video and voice information. The requested data is formed on the basis of predefined conditions such as the image of the face, entire body, or voice of the reading of predetermined sentences. In step 106, the formed data is transmitted to performer collecting company 1 through Internet.

Next, applicant 2-1 performs matters which should be done by the applicant included in the application conditions, for example the payment of a charge for appearance. In step 107, performer collecting company 1 makes sure that the matters defined in the application conditions are performed and notifies applicant 2-a that the conditions for appearance have been satisfied. In step 108, performer collecting company 1 edits the original promotion video based on the data acquired from performer 2-a to produce a promotion video in which performer 2-a appears. The editing refers to the replacement of the face or entire body of the performer in the original video and the replacement of his voice.

The completed video is transmitted to performer 2-a through Internet at step 109, and if he desires any revision, the procedure moves to step 108 to complete a final promotion video at step 110. Whether the video completed at step 108 is transmitted to performer 2-a to check if he desires any revision or the video is completed after simple mutual agreement depends on the conditions defined at the collection of performers.

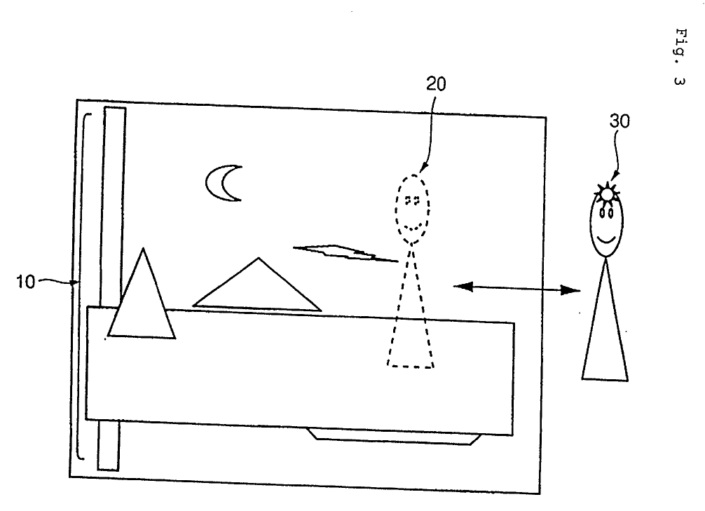

FIG. 3 shows a case in which part of the image of the performer in the original promotion video is replaced by an image of performer 2-a. In FIG. 3, numeral 10 denotes a scene in the promotion video, and numeral 20 denotes the image of the performer. Part of image 20 of the performer is replaced by image 30 of performer 2-a. The replacement of the image is performed, for example, with a method for displaying a composite moving image using computer graphics.

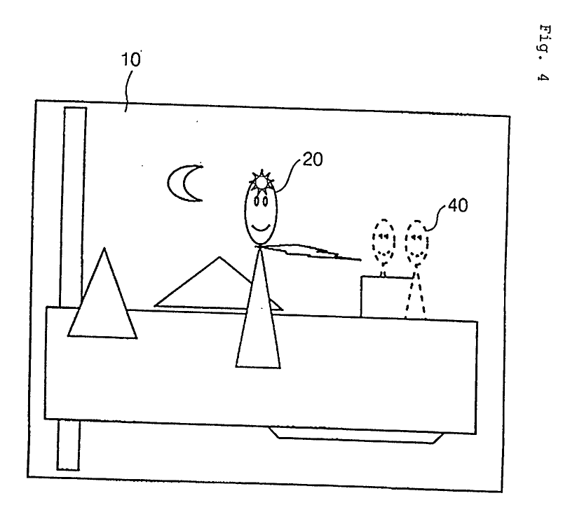

It should be noted that image 30 of performer 2-a does not necessarily replace a person playing a leading role, and for example, it is contemplated that performer 2-a appears in place of a supporting role or extra 40 as shown in FIG. 4. The promotion video completed through the aforementioned image processing is broadcast by way of the following procedure. Normally, the original promotion video is broadcast. The promotion video by way of which a collected performer appears is broadcast at unexpected times for viewers for a certain of period of time.

While a preferred embodiment of the present invention has been described using specific terms, such description is for illustrative purposes only, and it is to be understood that changes and variations may be made without departing from the spirit or scope of the following claims.

What is claimed is:

1. A method of collecting performers in a promotion video, comprising the steps of:
releasing collecting information for collecting performers in a commodity promotion video through the Internet;
receiving said collecting information through the Internet to display said collecting information on information terminals of applicants;
transmitting required information based on said collecting information to a performer collecting company from said information terminals; and
notifying a terminal of an applicant selected from said applicants based on the application information in said performer collecting company that said applicant can appear in said video.

2. The method according to claim 1, wherein said collecting information includes an original promotion video in which a performer appears for showing contents of the promotion video to said applicants.

3. The method according to claim 1, wherein said information provided by said applicant to said performer collecting company includes a photograph of said applicant and voice of reading of predetermined sentences.

4. A method of producing a promotion video comprising the steps of:
producing an original promotion video in which a performer appears;
producing an image of a performer collected in said performer collecting method according to claim 3 adapted to the image of the performer in said original promotion video;
producing a promotion video by replacing part of the image of the performer contained in said original promotion video by the image of said collected performer; and
producing a promotion video for broadcast by combining at a predetermined time ratio said original promotion video with said promotion video produced by using the image of said performer.

5. The method according to claim 4, wherein the part of the image of the performer in said original promotion video replaced by the image of said collected performer is of his face or part of his body.
